(19) United States
(12) Patent Application Publication
(10) Pub. No.: US 2010/0022266 A1
(43) Pub. Date: Jan. 28, 2010

(54) PILOT SIGNAL TRANSMISSION IN A RADIO COMMUNICATION SYSTEM

(75) Inventors: Eric R. Villier, Swindon (GB); Luis Lopes, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/518,290

(22) PCT Filed: Sep. 27, 2007
(86) PCT No.: PCT/US2007/079661

§ 371 Date: Jun. 9, 2009

(30) Foreign Application Priority Data
Jan. 24, 2007 (GB) 0701345.1

(51) Int. Cl. H04B 7/00

(52) U.S. Cl. 455/522

(57) ABSTRACT

An access point for a radio communication system transmits a pilot signal. The access point can operate in different modes with the pilot signal transmit power being controlled differently. A mode processor (105) controls a pilot signal controller (103) such that when in a first mode the access point is arranged to vary a pilot signal transmit power in accordance with a first transmit power profile. Another mode processor (107) controls the pilot signal transmit power in accordance with a second profile in a second mode. The transmit power may be constant during the second mode. A transition processor (111) is arranged to transition the access point from the first mode to the second mode in response to receiving an access request for a remote station.

### FIELD OF THE INVENTION

The invention relates to pilot signal transmission in a radio communication system and in particular, but not exclusively, to transmissions of pilot signals in cellular communication systems such as the Global System for Mobile communication (GSM) or the Universal Mobile Telecommunication System (UMTS).

### BACKGROUND OF THE INVENTION

Transmission of reference pilot signals is frequently used in radio communication systems. For example, in cellular systems, such as GSM or UMTS, the base stations transmit a reference or pilot signal (e.g. a beacon signal in CDMA/UMTS or a BCCH in GSM) that mobile stations use to make power measurements. These measurements can then be used directly by the mobile stations to perform cell selection and re-selection or are transmitted to the infra-structure for further processing. In essence, these measurements are used to determine the level of coverage/service that a mobile station obtains from a particular base station.

The reference/pilot signal is typically transmitted at a constant power level to provide a fixed reference for the mobile stations. This provides the advantage that the transmitted pilot signals clearly and simply define the coverage area of each individual cell and the pilot signal power level is therefore a critical factor for the operation and cell planning of a cellular system.

However, a disadvantage of using pilot signals is that a relatively high level of interference is constantly generated by the pilot signals merely to support cell detection and relocation. The generated interference is furthermore independent of the loading of the system and a substantial degree of interference is generated even by base stations not currently serving any mobile stations.

In addition, a number of other common channels are typically also transmitted with constant power levels which are often referenced with respect to the pilot signal (e.g. a fixed power offset is applied between the common signal and the pilot signal).

Thus, although the current approach provides a relatively simple and reliable operation it tends to introduce substantial interference and thereby reduce the capacity of the system and to potentially degrade other communications.

Furthermore, there is currently a trend towards an increasing use of large numbers of very small base stations or access points which have a very small coverage area (say 10-30 m) and which support only very few mobile stations. Indeed, in many situations, the access points will only occasionally support a communication and will typically be completely unloaded. However, in such systems the air interface resource used by the transmission of pilot signals becomes even more significant and tends to result in inefficient systems. Hence, an improved system would be advantageous and in particular a system allowing increased flexibility, reduced pilot signal interference while maintaining reliable and/or simple operation, practical implementation, improved capacity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an access point for a radio communication system, the access point comprising: means for operating in a first mode wherein the access point is arranged to vary a pilot signal transmit power in accordance with a first transmit power profile; means for operating in a second mode wherein the access point is arranged to control the pilot signal transmit power in accordance with a second transmit power profile; and means for transitioning the access point from the first mode to the second mode in response to receiving an access request for a remote station.

The invention may allow improved performance and specifically reduced interference and/or increased reliability. Specifically, the invention may allow the interference for pilot signal transmission to be reduced while maintaining high operational reliability by optimising the transmit power differently in different modes depending on remote station access characteristics. Specifically, the first transmit power profile may result in a temporarily varying transmit power thereby reducing the interference while, at least for some of the time, providing a transmit power sufficient to cover the whole intended coverage area for the access point. The second transmit power profile may correspond to a substantially constant pilot signal transmit power sufficient to ensure a reliable access procedure for the remote station.

The first and/or second transmit power profile may be time varying power profiles and may specifically be periodically repeating transmit power profiles.

The access request may e.g. be a request associated with a handover, a relocation, a registration or a call setup.

According to an optional feature of the invention the access point further comprises: means for operating in a third mode wherein the access point is arranged to set the pilot signal transmit power in response to a power control loop including the remote station; and means for transitioning to the third mode upon completion of an access procedure for the remote station.

The invention may allow improved performance and specifically reduced interference and/or increased reliability. Specifically, the invention may allow the interference caused by pilot signal transmissions to be reduced while maintaining high access reliability and efficient operation adapting to the current conditions during ongoing communications.

Completion of the access procedure may be determined in accordance with any suitable criterion such as e.g. when a specific event occurs or a specific message is received and/or transmitted.

According to another aspect of the invention, there is provided a cellular communication system comprising a plurality of access points, at least a first access point comprising: means for operating in a first mode wherein the first access point is arranged to vary a pilot signal transmit power in accordance with a first transmit power profile; means for operating in a second mode wherein the first access point is arranged to control the pilot signal transmit power in accordance with a second transmit power profile; and means for transitioning the first access point from the first mode to the second mode in response to receiving an access request for a remote station.

According to another aspect of the invention, there is provided a method of operation for an access point for a radio communication system, the method comprising: operating in a first mode wherein a pilot signal transmit power is varied in accordance with a first transmit power profile; operating in a second mode wherein the pilot signal transmit power is controlled in accordance with a second transmit power profile; and transitioning the access point from the first mode to the second mode in response to receiving an access request for a remote station.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an access point in accordance with some embodiments of the invention;

FIG. 2 is an illustration of a state diagram implemented by an access point in accordance with some embodiments of the invention; and

FIG. 3 is an illustration of a method of operation for an access point in accordance with some embodiments of the invention.

### DETAILED DESCRIPTION OF SOME EMBODIMENTS OF THE INVENTION

The following description focuses on embodiments of the invention applicable to an access point which is a base station of a 3^{rd} generation cellular communication system such as UMTS. In the example, the access point is a pico-cell base station supporting one pico-cell out of a large number of pico-cells underlaying a macro cell. It will be appreciated that the invention is not limited to this application but may be applied to many other radio communication systems including for example a GSM cellular communication system or Wireless Local Area Network (WLAN).

In the specific scenario, an access point in the form of a UMTS pico-cell base station supports a very small cell of e.g. 10-50 m radius. The access point is one of many small base stations supporting similar sized pico-cells. For example, the access points may support individual flats or floors of a large block of flats.

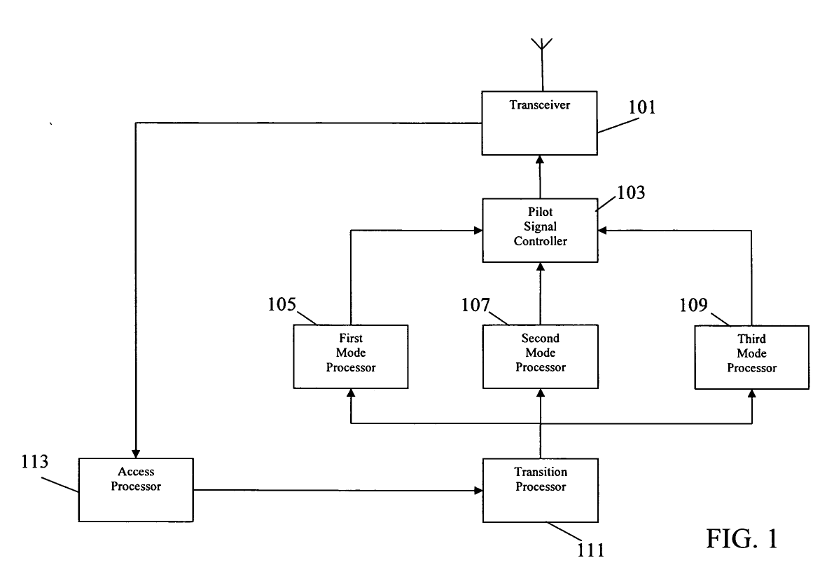

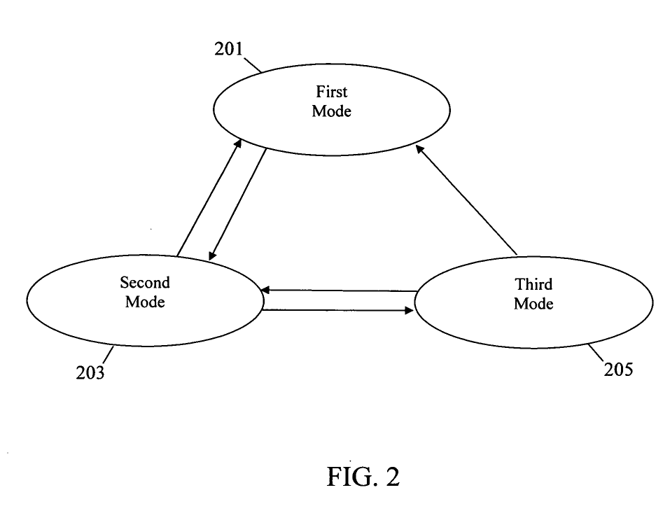

FIG. 1 is an illustration of an access point in accordance with some embodiments of the invention. In contrast to conventional UMTS base stations, the access point does not use a single constant transmit power for the pilots signal but is rather arranged to operate in three different states or modes with the pilot signal transmit power being set differently in each mode. The mode in which the access point is currently operating depends on the current status and specifically on whether the access point is currently not supporting any communications, whether it is in the process of setting up a new communication or whether it is supporting an ongoing communication. FIG. 2 illustrates a state diagram for the state machine implemented by the access point of FIG. 1.

Specifically, the access point comprises a transceiver 101 which communicates over the radio air interface in accordance with the UMTS air interface specifications. The transceiver 101 is furthermore capable of transmitting a UMTS pilot signal and is accordingly connected to a pilot signal controller 103 which generates the pilot signal that is transmitted by the transceiver 101.

The pilot signal controller 103 is coupled to a first mode processor 105, a second mode processor 107 and a third mode processor 109. Each of the mode processors 105, 107, 109 is arranged to control the transmit power of the transmitted pilot signal. The three mode processors 105, 107, 109 are coupled to a transition processor 111 which implements the state machine illustrated in FIG. 2. Specifically, when the access point is in the first mode of operation the first mode processor 105 is initiated to control the transmit power, when the access point is in the second mode of operation the second mode processor 107 is initiated to control the transmit power and when the access point is in the third mode of operation the third mode processor 109 is initiated to control the transmit power of the pilot signal.

The transition processor 111 is coupled to an access processor 113 which is furthermore coupled to the transceiver 101.

The transition processor 111 is arranged to transition between the different modes of operation depending on the current access state of the access point and specifically depending on whether the access point is currently in a situation where no remote stations are currently supported (in which case the access point is in the first mode), in a situation where one or more communications are currently supported (in which case the access point is in the third mode), or in a situation where an access process is currently performed for a remote station (in which case the access point is in the second mode). In the specific example a remote station is considered to be supported by the access point if any communication to or from the remote station will be via an air interface communication with the access point. Thus, a remote station is considered to be supported by an access point if the remote station is involved in an active uplink and/or downlink communication (e.g. a circuit switched call or a packet data session) with the access point. In addition, the remote station is considered to be supported if it is in a non-active mode but is still registered with the access point such that a communication setup with the remote station will be via the access point.

The access processor 113 is arranged to detect when a remote station accesses the access point and similarly when a remote station ceases to be supported by the access point. The access may for example be a handover or relocation of a remote station to the access point, or a registration or a call setup from or to a remote station served by the pico-cell.

The operation of the access point in the different modes of operation and the transition between these will be described in more detail in the following.

In the specific implementation scenario, the access point only relatively rarely supports any communication. For example, if the access point is only intended to cover a single flat, a communication is only supported if a person in that flat is performing a UMTS call. Thus, for the majority of the time, the access point is not supporting a communication for any remote station but is in a non-active state. In this case, the access point is in the first mode 201 and the transition processor 111 activates the first mode processor 105 and deactivates the second mode processor 107 and the third mode processor 109.

In the first mode of operation, the access point is arranged to vary the pilot signal transmit power in accordance with a first transmit power profile. Specifically, the first transmit power profile can correspond to a power variation between a minimum transmit power level (Pₘᵢₙ) and a maximum transmit power level (Pₘₐₓ) such that the pilot signal transmit power varies (slowly) with time between Pₘᵢₙ and Pₘₐₓ. The maximum transmit power level Pₘₐₓ is specifically set to correspond to the intended coverage area of the cell, i.e. it is equivalent to the constant transmit power that would be used in a conventional system.

The first mode processor 105 can specifically vary the transmit power periodically between the extreme power levels with the period selected to suit the individual embodiment and which provides a desired trade-off between interference reduction, operational reliability and delay of detection for remote stations at the edge of the cell.

The approach of applying a time varying transmit power profile with reduced power levels provides a mitigation of the interference degradation resulting from the constant-power pilot signals and downlink common channels. Allowing the access point to transmit the pilot signal with a power that varies with time provides a reduced average interference yet ensures that the transmit power is at least intermittently sufficiently high to cover the whole cell coverage area. Thus, even a remote station at the edge of the cell will be able to detect the pilot signal although there may be a slightly increased delay.

Hence, when no remote station is supported by the access point, the average transmit power is reduced below the nominal power level for the cell coverage area thereby reducing the interference to other cells or access points. For example, the first transmit power profile may be set to have an average transmit power that is only half of the maximum transmit power thereby resulting in the interference caused to other access point being halved. If all access points apply this approach in the specific example where access points are only rarely active, the total interference level caused by the transmission of pilot signals is almost halved.

Also, a reduced interference may also provide significant advantages for coexistence between macro-cells and pico-cells in scenarios where the same frequency is reused for the two layers or even if adjacent frequency bands are allocated to the different layers.

In the example, the transition processor 111 sets the access point in the first mode of operation when no remote station is supported by the access point.

It will be appreciated that any suitable criterion for when a remote station is supported can be applied. In the specific example, a remote station is supported if it is involved in an active communication with the access point or if it is attached to or registered with the access point in idle mode such that a paging for the remote station will be via the access point.

However, in other embodiments, a remote station may be considered to be supported only when it is involved in an active user data communication with the access point. For example, a remote station may be considered to be supported if it is registered and active for the access point but not if it is registered with the access point but is not involved in any active communications.

If the access point is currently not supporting any remote stations, and accordingly is operating in the first mode of operation 201, the access point may receive an access request from a remote station requesting that a communication for the remote station is supported by the access point.

For example, a relocation request, an attachment request, a registration request or a handover request may be received for a remote station via a fixed network of the cellular communication system coupled to the access point. E.g. a remote station may detect the pilot signal transmitted by the access point and in response a Radio Network Controller (RNC) currently supporting the remote station may initiate a relocation request (handover request) and transmit this to an RNC supporting the access point. The RNC can inform the access processor 113 of the receipt of such a request.

As another example, an access request may be received directly from the remote station via the transceiver and be fed to the access processor 113 which accordingly proceeds to execute the access process. For example, a remote station may initiate the setting up of a call by transmitting a suitable access message to the access point, such as e.g. an attachment or registration request message.

When an access initiation is detected, the access processor 113 informs the transition processor 111 of the initiation process. In response, the transition processor 111 transitions the access point from the first mode of operation 201 into a second mode of operation 203. The pilot signal transmit power is in the second mode of operation 203 controlled by the second mode processor 107 and accordingly the transition processor 111 deactivates the first mode processor 105 and activates the second mode processor 107.

In the second mode of operation 203, the second mode processor 107 controls the pilot signal to be transmitted with a transmit power that is in accordance with a second transmit power profile which is different from the first transmit power profile. Specifically, the second transmit power profile can correspond to a substantially constant transmit power level which furthermore may correspond to the coverage area of the cell, i.e. the second mode processor 107 can set the transmit power to Pₘₐₓ. In the specific example, the transmit power is thus maintained substantially constant during the access procedure. For example, a transmit power variation which is less than ±10% of the nominal transmit power (Pₘₐₓ) may be considered a substantially constant power.

Thus, when in the second mode of operation 205, the remote station has detected the pilot signal thereby indicating that the pilot transmit power was at suitable level. The access point is aware of the successful detection of the pilot signal as this has resulted in the access request. In response to the access request, the access point freezes the pilot signal transmit power at a suitable level which as mentioned before may be Pₘₐₓ.

In some embodiments, the substantially constant power level may be set at a lower level than Pₘₐₓ but which is considered sufficient for a successful access process. For example, the power level may be determined depending on the transmit power levels which have been detected in previous remote station accesses. For example, the access point may store the instantaneous transmit power level when an access request is received from a remote station. If the access request delay is relatively low compared to the speed of the transmit power variation, the instantaneous transmit power is a good indication of the pilot signal transmit power that was sufficient for detection by the remote station. The access point can utilize a number of such measurements to determine a suitable power level for the second mode of operation 203. For example, an average value or, say, a 90 percentile transmit power value may be selected as the substantially constant transmit power level.

The use of a substantially constant transmit power level during an access process can provide increased reliability and can specifically reduce the risk of a failure during the access process (e.g. during the handover). Specifically, it may allow the pilot signal and/or any linked common control or data channels to be reliably decoded at the remote station.

If the access process does not succeed, the transition processor 111 may return the access point to the first mode of operation 201. For example, if the radio conditions deteriorate such that no uplink signals are received from the remote station, the handover will fail and the access point will return to the first mode of operation 201.

As another example, if the access request is for a remote station which does not have permission to use the specific access point, the access point (or a serving RNC (Radio Network Controller)) can reject the request and the access process fails. The transition processor 111 accordingly returns the access point to the first mode of operation 201 by activating the first mode processor 105 and deactivating the second mode processor 107.

In some cases, the access point does not instantaneously return to the first mode of operation but may rather operate with a low pilot signal transmit power (such as Pₘᵢₙ or even lower) for a suitable time interval before returning to the first mode of operation 201. This may provide a time interval in which the remote station is unlikely to detect the access point and therefore more likely to register with a different access point (or e.g. move to a different pico-cell).

It will be appreciated, that in some embodiments the access point may only operate in two different modes and specifically that the access point may remain in the second mode of operation using a substantially constant pilot signal transmit power as long as an active remote station is supported. In such cases, the access point can transition from the second mode of operation 203 to the first mode of operation 201 when the communication is terminated thereby returning the access point to the non-active state with no active remote stations being supported.

However, in the specific example, the transition processor 111 is arranged to transition the access point to the third mode of operation 205 in response to a detection of the completion of the access procedure for the remote station. It will be appreciated that any suitable criterion may be used for determining that the access procedure has completed. For example, the generation of a handover complete message in response to receiving an access message from the remote station may be used as an indication that the access procedure has completed and the transition processor 111 may in response transition the access point to the third mode of operation 205 by deactivating the second mode processor 107 and activating the third mode processor 109.

When in the third mode of operation 205, the access point supports one or more communications from one or more remote stations. Thus, at least one remote station is actively supported by the access point. Accordingly, the access point and at least one remote station may implement a power control loop which can be used to set the pilot signal transmit power. Thus, in the third mode of operation, the active communications are used to set the pilot signal transmit power to a level which is sufficient to support the active remote stations while being reduced from a maximum level in order to reduce the interference level. Thus reliable operation is achieved with reduced interference.

Thus in the third mode 205, the access point is in slow power control mode and it tracks the minimum pilot signal transmit power required e.g. in order to decode the pilot signal and/or any linked common channels. For the specific UMTS example, the power control may be implemented in different ways.

For example, the remote station(s) can transmit “power up” or “power down” commands to the access point in order to maintain the pilot power at the minimum suitable level. The third mode processor 109 can increase the pilot signal transmit power if a “power up” command is received and reduce it if a “power down” command is received.

In the case of multiple remote stations being simultaneously supported by the access point, the third mode processor 109 can reduce the pilot signal transmit power only if all involved remote stations request a power reduction, i.e. only if all remote stations transmit a “power down” command. Thus, the access point can apply the following rule: if at least one remote station sends a “power up” command, the access point increases the pilot signal transmit power and otherwise (all registered remote stations sending a “power down” command) the access point decreases the pilot power.

As another example, if the remote station is in DCH connected mode, the remote stations can regularly transmit signal to noise measurements for the pilot signal. Specifically Common Pilot Channel (CPICH) Ec/No measurements are reported to the access point and may be used to slowly power control the pilot signal transmit power. Thus, this approach can be used to determine a minimum power level Pₘᵢₙ′ which is sufficient for all active remote stations.

Specifically, one of the two following techniques may be used:
1. The access point can request periodic CPICH Ec/No reports and compare them to a settable threshold. If the Ec/No value is less than the threshold, the pilot signal transmit power is increased and otherwise it is decreased.
2. Event-triggered reports such as the 3GPP-defined event 1e and event if can be used to provide Ec/No measurements for power control of the pilot signal transmit power. E.g. the remote station can be configured (via an RRC Measurement Control message) to trigger a measurement report if the Ec/No falls below a given settable threshold and the access point will then (slowly) increase the pilot signal transmit power until it receives an event 1e measurement report from the remote station thereby indicating that the pilot signal Ec/No has increased above another settable threshold (the two thresholds could be the same but some hysteresis will typically be preferable).

If the remote station is not in DCH connected mode, the access point can request Ec/No reports from the remote station on a regular basis.

It will be appreciated that the access point can filter the “power up” and “power down” commands sent by the remote stations to e.g. average them (for each remote station) over a reasonable period of time (thereby being consistent with the desired effect of slowly controlling the pilot power).

In addition to using the slow power control to set the pilot signal transmit power to a level which is just enough to support the currently active remote stations, the third mode processor 109 may also vary the pilot signal transmit power in accordance with a third transmit power profile during one or more time intervals. The third transmit power profile may be selected such that the pilot signal transmit power is slowly increased up to the maximum power level (Pₘₐₓ) and subsequently is reduced back to the power control determined transmit power level Pₘᵢₙ′.

Specifically, during the time interval a pilot signal transmit power variation corresponding to that performed in the first mode of operation 201 may be performed but with the variation being limited by a minimum transmit power level corresponding to a transmit power determined by the power control loop.

The temporary variation of the pilot signal transmit power in accordance with the third transmit power profile may be repeated at suitable intervals such as at regular intervals or in response to specific events.

This power variation may ensure that any new remote stations within the coverage area of the cell will be able to detect the pilot signal despite it being power controlled to a minimum level sufficient to support the currently active remote stations during e.g. the majority of the time. Thus, reliable operation is achieved while reducing the interference caused by transmission of pilot signals.

If the access point receives an access request from a remote station while operating in the third mode of operation 205, the transition processor 111 will transition the access point back to the second mode of operation 203 wherein the pilot signal transmit power is maintained substantially constant in order to ensure a reliable access procedure.

The transition processor 111 is furthermore arranged to transition the access point from the third mode of operation 205 to the first mode of operation 201 in response to a detachment of the remote station where a detachment may be any event that results in the remote station no longer being supported by the access point, such as e.g. a handover to another cell. Specifically, if the last remote station detaches such that no active communications are supported by the access point, the access point returns to the first mode of operation corresponding to the non-active mode where no remote stations are actively supported.

It will be appreciated that any suitable criterion for determining that a remote station is considered supported may be used. For example, a remote station may be considered supported if it is currently engaged in a communication which is supported by the access point and detached otherwise.

The detachment of the remote station may be detected in response to an orderly termination of the ongoing communication. However, a detachment may also be detected in response to a failure of the ongoing communication, such as the loss of the radio propagation channel between the remote station and the access point. For example, if the access point stops receiving “power up” or “power down” commands from a previously-registered remote station, the access point can return to the first mode of operation 201.

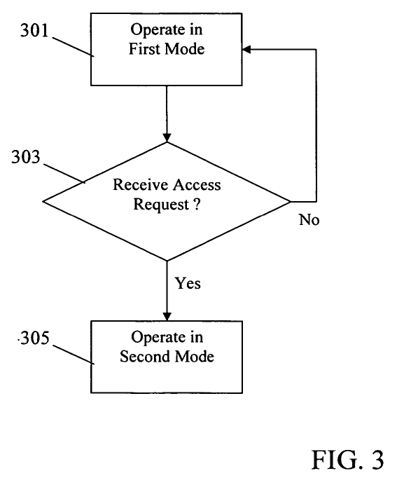

FIG. 3 illustrates an example of a method of operation for an access point in accordance with some embodiments of the invention.

The method initiates in step 301 wherein the access point operates in a first mode wherein a pilot signal transmit power is varied in accordance with a first transmit power profile.

Step 301 is followed by step 303 wherein the access point determines if an access request has been received for a remote station. If so, the access point transitions to a second mode and the method proceeds in step 305 wherein the pilot signal transmit power is controlled in accordance with a second transmit power profile. Otherwise, the method returns to step 301.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An access point for a radio communication system, the access point comprising:
means for operating in a first mode wherein the access point is arranged to vary a pilot signal transmit power in accordance with a first transmit power profile;
means for operating in a second mode wherein the access point is arranged to control the pilot signal transmit power in accordance with a second transmit power profile; and
means for transitioning the access point from the first mode to the second mode in response to receiving an access request for a remote station.

2. The access point of claim 1 wherein the first transmit power profile corresponds to a power variation between a minimum transmit power level and a maximum transmit power level, the maximum transmit power level corresponding to a coverage area of the cell.

3. The access point of claim 1 wherein the second transmit power profile corresponds to a substantially constant transmit power level that depends on previous power controlled pilot signal transmit power levels.

4. The access point of claim 1 further comprising means for transitioning the access point from the second mode to the first mode in response to a detection of an access failure for the remote station.

5. The access point of claim 1 wherein the access point is arranged to operate in the first mode when no remote station is supported by the access point.

6. The access point of claim 1 further comprising:
means for operating in a third mode wherein the access point is arranged to set the pilot signal transmit power in response to a power control loop including the remote station; and
means for transitioning to the third mode upon completion of an access procedure for the remote station.

7. The access point of claim 6 further comprising means for transitioning from the third mode to the second mode in response to receiving an access request for a second remote station.

8. The access point of claim 6 wherein the power control loop involves a plurality of remote stations and the access point is arranged to reduce the pilot signal transmit power only if all involved remote stations request a power reduction.

9. The access point of claim 6 further comprising means for transitioning from the third mode to the first mode in response to a detachment of the remote station.

10. A method of operation for an access point for a radio communication system, the method comprising:
operating in a first mode wherein a pilot signal transmit power is varied in accordance with a first transmit power profile;
operating in a second mode wherein the pilot signal transmit power is controlled in accordance with a second transmit power profile; and
transitioning the access point from the first mode to the second mode in response to receiving an access request for a remote station.
